(19) United States
(12) Patent Application Publication
(10) Pub. No.: US 2013/0213665 A1
(43) Pub. Date: Aug. 22, 2013

(54) Apparatus Including Water-Soluble Material for Use Downhole

(71) Applicant: Edward J. O'Malley, Houston, TX (US)

(72) Inventor: Edward J. O'Malley, Houston, TX (US)

(73) Assignee: BAKER HUGHES INCORPORATED, HOUSTON, TX (US)

(21) Appl. No.: 13/401,048

(22) Filed: Feb. 21, 2012

(51) Int. Cl. E21B 34/06; C09K 8/72

(52) U.S. Cl. 166/373; 166/317; 507/269

(57) ABSTRACT

In one aspect, a device for use downhole is provided that in one embodiment includes a member having a composite material reinforced with a water-soluble material. In another aspect a method of performing an operation in a wellbore is disclosed that in one embodiment includes placing a device at a selected location in the wellbore, which device includes a member having a composite material reinforced with a water-soluble material, performing the operation and allowing the water-soluble material to dissolve at least partially in the wellbore.

### BACKGROUND OF THE DISCLOSURE

1. Field of the Disclosure

The disclosure relates generally to apparatus and methods relating to removable downhole devices.

2. Description of the Related Art

Hydrocarbons such as oil and gas are recovered from a subterranean formation using a well or wellbore drilled into the formation. In some cases the wellbore is completed by placing a casing along the wellbore length and perforating the casing adjacent each production zone (hydrocarbon bearing zone) to extract fluids such as oil and gas from the associated a production zone. In other cases, the wellbore may be an open hole, i.e. no casing. Often, devices such as bridge plugs are temporarily installed in the wellbore to perform an operation downhole, which devices are removed after the intended operation has been performed. Typically, to perform an operation, devices such as bridge pugs, are securely attached to the wellbore, the operation is performed while the device is in the wellbore and the device is then removed. Typically, a milling tool is conveyed into the wellbore to mill or destroy the device. Milling operations can require substantial time to execute. It is therefore desirable to provide devices that can be milled or otherwise destroyed easily and in less time.

The disclosure herein provides devices for downhole use that include a material which when exposed to a downhole fluid, such as water, dissolves in the fluid, thereby aiding the destruction of such devices.

### SUMMARY

In one aspect, the disclosure provides a device for use downhole that in one embodiment includes a member having a composite material reinforced with a material that dissolves when exposed to water contained in a downhole fluid. In one aspect, the reinforcing material includes soluble glass fibers.

In another aspect, a method of performing an operation in a wellbore is disclosed that in one embodiment includes: placing a device at a selected location in the wellbore, wherein the device includes a member having a composite material reinforced with a water-soluble material; performing the operation; allowing the water-soluble material to dissolve at least partially; and removing the device from the wellbore.

In yet another aspect, a method of making a device is disclosed that in one embodiment includes providing a member for use in the device that includes a base material reinforced with a water-soluble material. In one embodiment the base material is a composite resin and the water-soluble material includes glass fibers.

Examples of the more important features of the disclosure have been summarized rather broadly in order that detailed description thereof that follows may be better understood, and in order that the contributions to the art may be appreciated. There are, of course, additional features of the disclosure that will be described hereinafter and which will form the subject of the claims appended hereto.

### BRIEF DESCRIPTION OF THE DRAWINGS

The advantages and further aspects of the disclosure will be readily appreciated by those of ordinary skill in the art as the same becomes understood by reference to the following detailed description when considered in conjunction with the accompanying drawings, in which like reference characters generally designate like or similar elements throughout the several figures of the drawings, and wherein:

FIG. 1 is a schematic elevation view of an exemplary multi-zone wellbore showing perforation operation being performed by a work string that includes devices made according an embodiment of the disclosure;

FIG. 2 shows a partial cross-section view of an exemplary isolation device made according to an embodiment of the disclosure that may be utilized in the wellbore operation shown in FIG. 1;

FIG. 3 shows a sectional view of a cone member made according to one embodiment of the disclosure for use in a device, such as the isolation device, shown in FIG. 2; and

FIGS. 4A and 4B show a cross-sections of another member made according to another embodiment of the disclosure for use in a device, such as an isolation device; shown in FIG. 2.

### DESCRIPTION OF THE DISCLOSURE

The present disclosure, in general, relates to devices or apparatus and methods for use in wellbores, wherein the apparatus is removed after performing a work or operation in the wellbore. Bridge plugs, packers and seals are some of the examples of such devices. The present disclosure provides certain exemplary drawings to describe certain embodiments of the apparatus and methods that illustrate the principles described herein. They are not intended to limit the concepts and disclosure to the illustrated and described embodiments or to limit the scope of the claims.

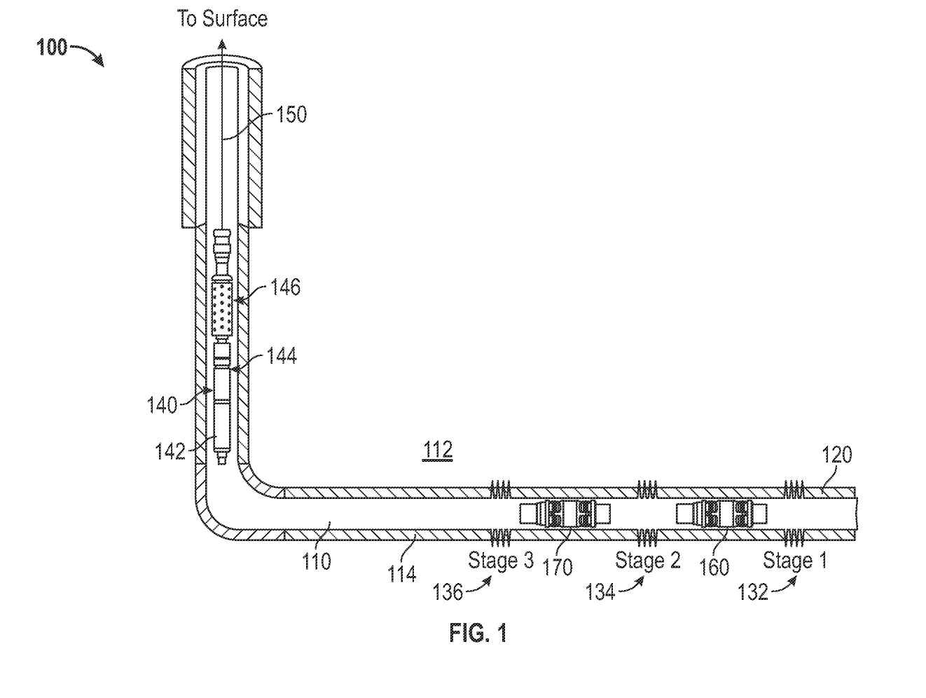

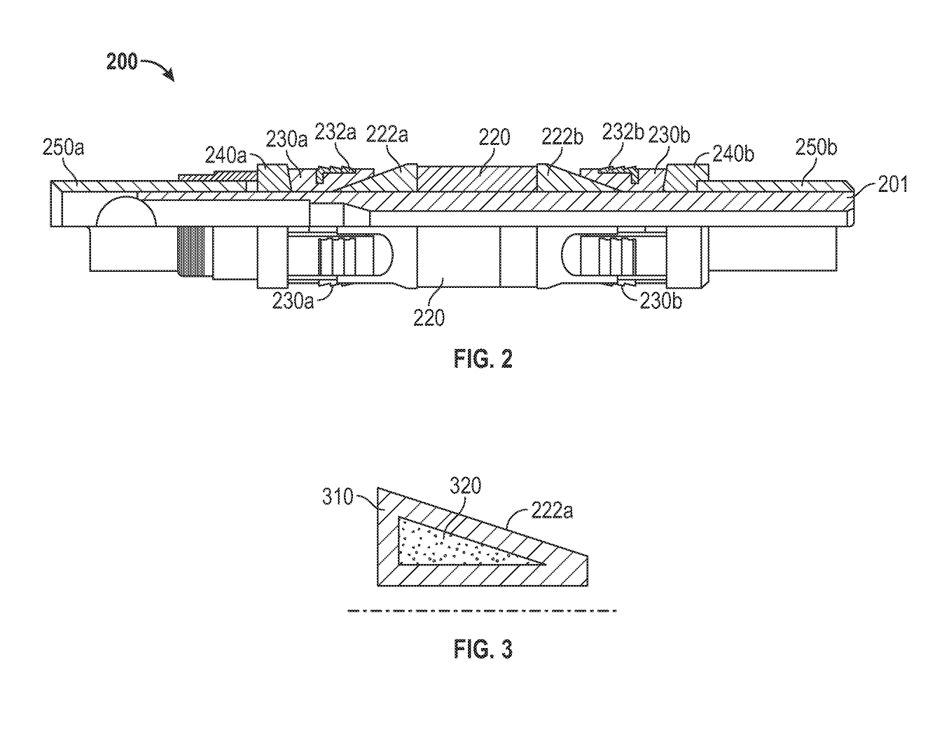

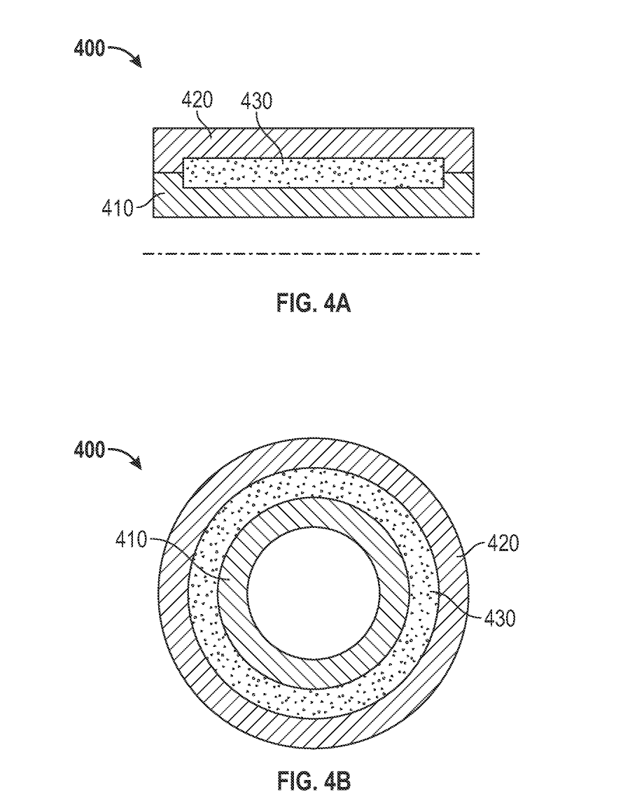

FIG. 1 shows an exemplary wellbore system 100 for perforating a work or an operation in wellbore 110 drilled through an earth formation 112. The wellbore 110 is shown lined with a casing 114. The wellbore system 100 includes a perforating string 140 that includes an isolation device 142, such as a bridge plug, a setting tool 144 and a perforating gun 146. The string 140 is shown conveyed into the wellbore 110 by a conveying member 150 that may be any suitable member, such as a wireline, coiled tubing, slick line, etc. FIG. 1 shows the string 140 for perforating a number of zones or stages, stage 1 (132), stage 2 (134) and stage 3 (136). To perforate the first stage 132, i.e., the stage at the farthest depth or distance from the surface 101, the string 140 may be conveyed with the perforating gun 146, without the setting tool isolation device 144 and its corresponding setting tool 146. The gun is then fired to perforate the first stage 132. To perforate the second stage, such as stage 134, the string containing an isolation device 142, a setting tool 144 and a perforating gun 146 is conveyed in the wellbore 110. The setting tool 144 is activated to set the isolation device at location 160 past the location of stage 2 (134) so as to isolate the wellbore section containing stage 134 from the already perforated first stage 132. The gun 146 is then fired to perforate the wellbore at the second stage 134. The bridge plug is then removed by one of the methods described later herein and the string 140 is removed from the wellbore. Removal of the isolation device typically involves destroying the isolation device. The string 140 is once again conveyed into the wellbore with a new isolation device along with an associated setting device and a new perforating gun. The process described is repeated to perforate the third stage 136. Additional stages uphole of the third stage may also be perforated in the manner described above. In the system and method, described above, the isolation device 142 is temporarily located in the wellbore to isolate a lower section of the wellbore from an upper section of the wellbore. The isolation device is typically milled and removed. The isolation devices made according an embodiment dissolve over a time period or when exposed to a water-base fluid in the wellbore, such as by milling the isolation device that causes the isolation to dissolve, thereby facilitating the removal process, as described in more detail below in reference to FIGS. 2, 4A and 4B.

FIG. 2 shows a half cross-section view of an exemplary isolation device 200 made according to an embodiment of the disclosure that may be utilized in a wellbore, such as shown in FIG. 1. The particular isolation device 200 shown is a bridge plug used for fracing. The device 200 includes a mandrel 201 that may be made from a composite or another suitable material. A packing element 220, such as packer made from a suitable elastomeric material is placed around the mandrel 201. The packing element 220 is configured to expand and set against the wellbore wall or the casing, such as casing 120 shown in FIG. 1. Cones 222a and 222b are placed on either side of the packing element 220, which cones when urged toward the packing element cause the packing element 220 to expand outward and urge against the casing 120. In aspects, the cones 222a and/or 222b are made according one of the embodiments of this disclosure as described in reference to FIGS. 3, 4A and 4B. The device 200 further includes a first slip 230a on the mandrel 201 abutting the cone 222a and a second slip 230b abutting the slip 222b. Slips 230a and 230b may be molded elastomeric member, each slip including a metal insert, such as metal insert 332a in slip 230a and metal insert 322 in slip 330b. A load ring 240a is provided next to the slip 230a while a load ring 240b is provided next to slip 230b. Moving the load rings 240a and 240b are toward the packing 220 causes the slips 230a and 230b to expand leading the metal inserts 232a and 232b to bite into the casing 120 and also causes the packing element to compress, which expands the packing element 220 outward and causes it to urge against the wellbore to provide a seal from a lower section of the wellbore. An upper sleeve 250a and a lower sleeve 250b are provided on the mandrel on either side of the load rings to retain the packing element, cones and slips in their positions around the mandrel 201. To activate the packing element 220 and the slips, a setting tool (not shown) is conveyed into the wellbore to apply the required force onto the load rings 240a and 240b to cause the slips 230a and 230b and the packing element 220 to set against the wellbore or the casing 120.

Referring back to FIG. 1, to place a device such as device 200, the device is placed at a selected location, such as shown in reference to devices 160 and 170, the setting tool, such as tool 144 is used to set the device 200 in such selected location. Although, the device shown and described in FIG. 2 is a particular type of removable isolation device, any other isolation device or any other device that is anchored in the wellbore for performing an operation and removed after the operation has been performed may be made according an embodiment of the disclosure.

FIG. 3 shows a cross-sectional view of a cone, such as cone 222a shown in FIG. 2, made according to one embodiment of the disclosure. The cone 222a includes an outer layer 310 made from a material that is either non-soluble in water or allows the water in the wellbore to penetrate through the outer layer over time. The inner mass 320 of the cone 222a includes a water-soluble material. In one embodiment, the outer layer 310 is made from a suitable composite resin and the water-soluble material includes glass fibers. In aspects, the thickness of the outer layer 310 is selected based on the desired rate of penetration of the water, which rate may depend upon the downhole temperature and pressure. The pressure downhole often exceeds 10,000 psi and temperature can reach 200 degrees centigrade. The type of the composite resin selected and the thickness of the outer layer may be selected based on the experimental data that show the rate of penetration as a function of temperature and/or pressure under downhole conditions. The thickness of the layer may vary around the inner mass 320 based on the erosion factor at various locations of the cone 222a. Other parts of the device 200 may also be made using water-soluble materials.

FIGS. 4A and 4B respectively show axial and radial cross-sections of an exemplary longitudinal tubular member 400 made using water-soluble material, according to the methods described. The member 400 may be used as sleeves 250a and 250b and/or as the mandrel 201 in the embodiment of the device 200 shown in FIG. 2. The member 400 includes an inner longitudinal mandrel or core member 410 and an outer mandrel 420, each made from a non-water soluble material or a material that will degrade over time due to exposure to the downhole fluid. A reinforcement member 430, made using a water-soluble material, is placed between the inner and outer mandrels 410 and 420. The reinforcement member 430 is encapsulated by the inner and outer mandrels 410 and 420 so it is not exposed directly to the downhole fluid when it is placed in the wellbore. The member 400 may be attached to a tubular by any suitable manner. FIGS. 3, 4A and 4B provide exemplary elements made according to the embodiments, however; any member or device may be made using the concepts and methods described here for use in downhole environment, including, but not limited to, devices that are installed for temporary use, isolation devices, bridge plugs and frac plugs.

For the purpose of this disclosure any suitable water-soluble material may be utilized as the reinforcing material. In one aspect, a silica glass insoluble in water may be processed to render it or other glass-like materials water soluble and used in that form. In aspects, fibers made from the water-soluble glass may be used as the reinforcing fibers in composites materials used in disposable devices downhole structures, such as bridge plugs, to expedite their removal, such as during milling of such disposable structures. In various embodiments, soluble glass fibers are internal to the solid composite resin structures and remain out of water contact until a destructive process such as milling begins. In practice, upon the start of the milling process, the soluble glass fibers are exposed to an aqueous well-fluid that hastens the destruction of the disposable structure. In other applications, the protective layer in the disposable structure may be designed to degrade over a selected time period to allow the water-soluble reinforced material to the water to hasten the destruction of such device.

It should be understood that FIGS. 1-4B are intended to be merely illustrative of the teachings of the principles and methods described herein and which principles and methods may applied to design, construct and/or utilizes inflow control devices. Furthermore, foregoing description is directed to particular embodiments of the present disclosure for the purpose of illustration and explanation. It will be apparent, however, to one skilled in the art that many modifications and changes to the embodiment set forth above are possible without departing from the scope of the disclosure.

1. A device for use in a wellbore, comprising:
a composite material reinforced with a water-soluble material configured to dissolve when exposed to fluid in the wellbore.

2. The device of claim 1, wherein the water-soluble material includes water-soluble glass fibers.

3. The device of claim 1 further comprising a protective material on the composite material that protects the water-soluble material from exposure to the fluid in the wellbore until the protective layer is punctured.

4. The device of claim 1 further comprising a protective layer configured to protect the water-soluble material from exposure to the fluid in the wellbore for a selected time period.

5. The device of claim 1, wherein the device includes a first member that causes a second member to engage the wellbore and wherein the first member includes the composite material and the water-soluble material.

6. The device of claim 5, wherein the second member is selected from a group consisting of: a slip and a packing element.

7. An apparatus for use in a wellbore, comprising:
an isolation device that includes:
a mandrel;
a first member on the mandrel configured to engage with the wellbore;
a sliding member configured to cause the first member to engage with the wellbore; and
wherein one of the mandrel and the second member includes a composite resin material and water-soluble glass configured to dissolve when that composite material is exposed to water in the wellbore.

8. The apparatus of claim 8 further comprising:
a conveying member configured to convey the isolation device into the wellbore; and
a perforating device carried by the conveying member and configured to perforate the wellbore.

9. The apparatus of claim 8 further comprising a setting tool carried by the conveying member configured to set the isolation device in the wellbore.

10. A method of performing an operation in a wellbore that includes a fluid containing water, comprising:
placing a device at a selected location in the wellbore, wherein the device includes a member having a composite material reinforced with a water-soluble material that is configured to dissolve in water in the wellbore;
performing the operation in the wellbore while the device is in the wellbore;
allowing the water-soluble material to dissolve; and
removing the device when the water-soluble material has dissolved at least partially.

11. The method of claim 10, wherein placing the device includes conveying the device by a conveying member.

12. The method of claim 11, wherein the device is an isolation device.

13. The method of claim 12, wherein the operation is perforating a zone in the wellbore.

14. The method of claim 11, wherein the water-soluble material is protected from the downhole environment until the device is milled to expose the water-soluble material to the downhole fluid.

15. The method of claim 11, wherein the water-soluble material is water-soluble glass.

16. The method of claim 11, wherein the member further comprises a protective layer configured to protect the water-soluble material from exposure to wellbore fluid for a selected time period.

17. The method of claim 11, wherein the device includes a first member that causes a second member to engage the wellbore and wherein the first member includes the composite material and the water-soluble material.

18. The method of claim 17, wherein the second member is selected from a group consisting of: a slip; and a packing element.

19. A method of making a device for use downhole, the method comprising:
providing a base material;
reinforcing the base material with a water-soluble material in a manner that protects the water-soluble material from exposure to the outside environment.

20. The method of claim 19, wherein the base material is a composite material and the water-soluble material is glass.
